(19) United States
(12) Patent Application Publication
(10) Pub. No.: US 2012/0010400 A1
(43) Pub. Date: Jan. 12, 2012

(54) DUALLY SUBSTITUTED ZINC PHTHALOCYANINE COMPOSITION, PROCESS OF PREPARING THE SAME AND USE THEREOF

(75) Inventors: Naisheng Chen, Fuzhou (CN); Jinling Huang, Fuzhou (CN); Jinping Xue, Fuzhou (CN); Hong Liu, Fuzhou (CN); Jian Wang, Fuzhou (CN); Jundong Wang, Fuzhou (CN); Zhou Jiang, Fuzhou (CN)

(73) Assignee: FUZHOU UNIVERSITY, Fuzhou (CN)

(21) Appl. No.: 13/025,380

(22) Filed: Feb. 11, 2011

(30) Foreign Application Priority Data
Jul. 12, 2010 (CN) 201010224042.5

(51) Int. Cl. C09B 47/04

(52) U.S. Cl. 540/123

(57) ABSTRACT

The invention discloses a pharmaceutical composition used in photodynamic therapy for cancer or precancerous lesions. The composition includes four isomers of zinc phthalocyanine. Furthermore, this invention also provides an industrial chromatography preparation process. The composition is synthesized by separating 10 cis-isomers from disulfonic acid diphthaloyl iminomethyl zinc phthalocyanine, and then separating among them 4 isomers with significant amphiphilic property. It is evident that the composition of the invention shows improved performance compared to compositions containing those 10 cis-isomers.

### BACKGROUND OF THE INVENTION

1. Field of the Invention

The present invention relates to a dually substituted zinc phthalocyanine composition, a process of preparing the same and a use thereof. More particularly, the present invention relates to a zinc phthalocyanine composition which can be used as a photosensitizer in photodynamic therapy.

2. Related Prior Art

Intensive researches on phthalocyanine compounds as photosensitizers in photodynamic therapy for diseases such as cancers have been widely made in recent years. The conventional discloses a method of preparing phthalocyanine metal complexes which uses 4-sulfonic acid potassium phthalonitrile and 4-phthaloyl iminomethyl phthalonitrile as starting substances. First of all, within a lithium solution in alcohol, semi-sulfonic acid potassium substituted phthalocyanine zinc and phthaloyl iminomethyl substituted semi-zinc phthalocyanine are formed as precursors. Then, cyclization reaction is carried out in 2-ethoxyethanol to form bis(sulfonic acid potassium)bis(phthaloyl iminomethyl) lithium zinc phthalocyanine intermediates which then react with metal salts in DMF to form amphiphilic zinc phthalocyanine complexes corresponding to the core metals in the metal salts.

The obtained zinc phthalocyanine composition from the above synthesis contains isomers of complicate structures and components. For example, disulfonic acid potassium phthaloyl iminomethyl zinc phthalocyanine contains 10 cis-isomers and 5 trans-isomers. In this disclosed content of the present invention, disulfonic acid potassium phthaloyl iminomethyl zinc phthalocyanine and the salt thereof are referred to as ZnPcS₂P₂. There may be some varieties in definition of the term ZnPcS₂P₂ with different substituent groups in similar forms. For example, if a ring of zinc phthalocyanine has 3 —S substituent groups and 1 —P substituent group, it is referred to as ZnPcS₃P. If the ring of zinc phthalocyanine has 2 —S substituent groups and 2 —P substituent groups, it is referred as to ZnPcS₂P₂. Therefore, formula of zinc phthalocyanine can be ZnPcS₄, ZnPcP₄, ZnPcSP₃ etc., depending on the number of —S and —P substituent groups. The —S substituent group can be sulfonic acid group or salts thereof. The —P substituent group can be phthaloyl iminomethyl. However, the difference in photodynamic therapy effect between various isomers of zinc phthalocyanine has not been studied yet. No process of separating specific isomers with significant effect in photodynamic therapy from the isomer mixture has been proposed, neither.

The present invention is therefore intended to obviate or at least alleviate the problems encountered in prior art, especially in terms of flexibility of special arrangement.

### SUMMARY OF THE INVENTION

It is an objective of the present invention to provide a dually substituted zinc phthalocyanine composition used in photodynamic therapy for cancer or precancerous lesions, an use of zinc phthalocyanine in pharmaceutical application, and an application of zinc phthalocyanine to an industrial chromatography preparation process.

In order to achieve the above and other objectives, the invention provides a pharmaceutical composition containing zinc phthalocyanine composition. The above zinc phthalocyanine composition includes the following four isomers of zinc phthalocyanine:

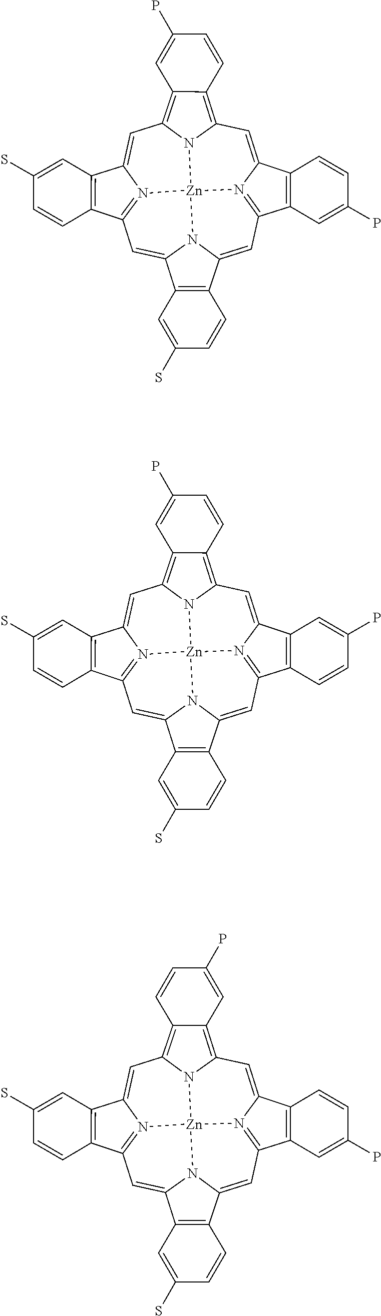

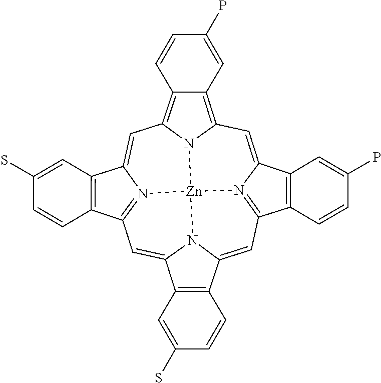

wherein —S— is —SO₃⁻M⁺, and M⁺ is a pharmaceutically acceptable cation; —P is

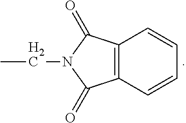

The invention further provides the use of a zinc phthalocyanine composition used in photodynamic therapy for cancer or precancerous lesions, wherein the above zinc phthalocyanine composition includes the following four isomers of zinc phthalocyanine,

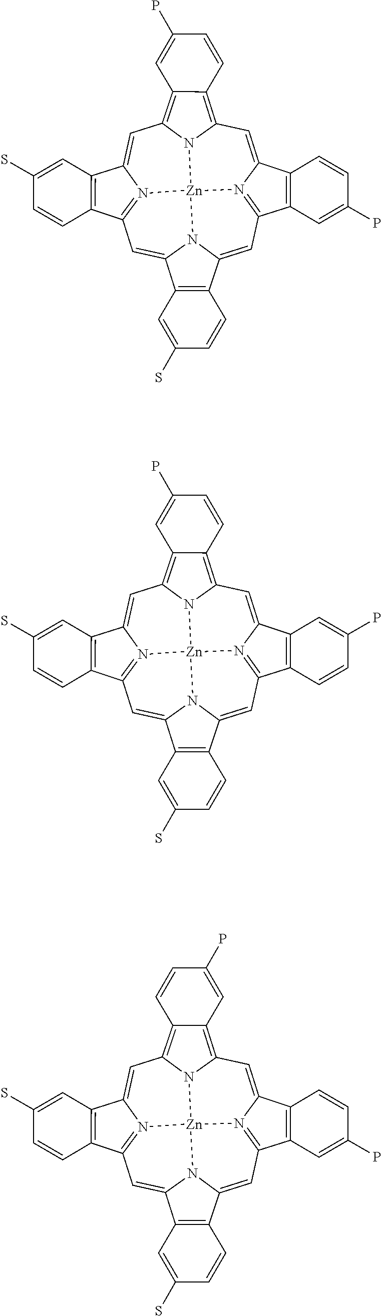

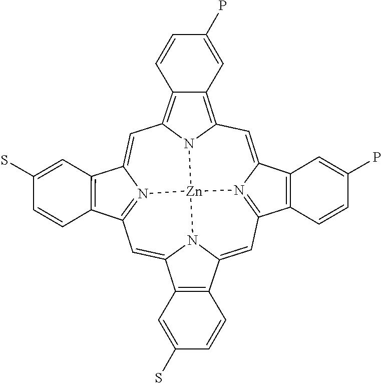

wherein —S— is —SO₃⁻M⁺, and M⁺ is a pharmaceutically acceptable cation; —P is

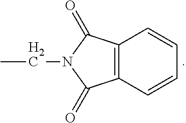

The invention also provides a process of preparing zinc phthalocyanine, wherein starting substances used in the process include ZnPcS₄, ZnPcS₃P, ZnPcS₂P₂, and ZnP_{c}P₄, and the process includes the following steps:

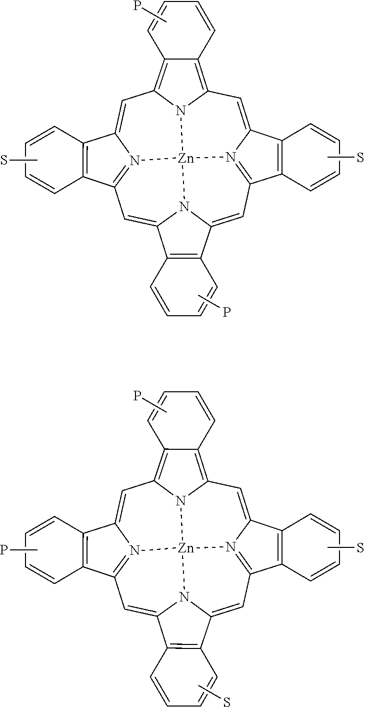

wherein —S— is —SO₃⁻M⁺, and M⁺ is a pharmaceutically acceptable cation; —P is

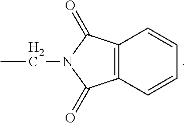

1) Rough separation:
a. Balancing through a rough separation column: the rough separating column has a packed length of 300˜1000 mm, a diameter of 50˜200 mm, a pore diameter of 100˜120 Å, carbon loading of 17%˜19%, with C18 fillers having particle size of 20˜50 μm,
b. Injection: take starting substances to make a 65% to 70% (volume) DMF aqueous solution with pH 7.0 to 8.0. The aqueous solution is pumped into the rough separation column. In the above solution, the content of zinc phthalocyanine is 0.2% to 0.5% of filler weight. The concentration of zinc phthalocyanine is 8˜15 g/L. The injection column temperature is 20˜35° C. The injection flow rate=S×a, where S is cross-sectional area of the rough separation column, in units of cm², and a is a coefficient in the range of 2.5˜5.0 cm;
c. Elution: pH 7.0˜8.0 DMF aqueous solutions at different concentrations are used in turns for elution. The concentration of the above DMF solutions is in the range of 10% to 100% (volume). During the elution process, a low-concentration DMF solution is first pumped into the column, and then a high-concentration DMF solution is pumped. According to the composition of the eluent used here, cis-enriched fractions of zinc phthalocyanine are sequentially collected. The eluting column temperature is 20˜35° C. The elution flow rate=S×a, where S is cross-sectional area of the rough separation column, in units of cm², and a is a coefficient in the range of 2.5˜5.0 cm;
2) Fine separation:
a. Balancing through a fine separating column: The fine separation column has a packed length of 700˜1000 mm, a diameter of 100˜200 mm, a pore diameter 100˜120 Å, a carbon loading of 19% 21%, with C18 fillers having particle size of 10˜20 μm,
b. Injection: take the roughly separated substances to make a 60% to 65% (volume) DMF aqueous solution with pH 8.0 to 8.2. The aqueous solution is pumped into the fine separation column. In the above solution, the content of zinc phthalocyanine is 0.10% to 0.12% of filler weight. The concentration of zinc phthalocyanine is 5˜10 g/L. The injection column temperature is 20˜35° C. The injection flow rate=S×a, where S is cross-sectional area of the fine separation column, in units of cm², and a is a coefficient in the range of 0.85˜1.3 cm;
c. Elution: pH 8.0˜8.2 DMF aqueous solutions at different concentrations of 60%˜65% (volume) are used as a flowing phase for elution in the fine separation column. The eluting column temperature is 20˜35° C. The elution flow rate=S×a, where S is cross-sectional area of the fine separation column, in units of cm², and a is a coefficient in the range of 0.85˜1.3 cm. According to the composition of the eluent used here, four isomer-enriched fractions of zinc phthalocyanine as shown below are collected:

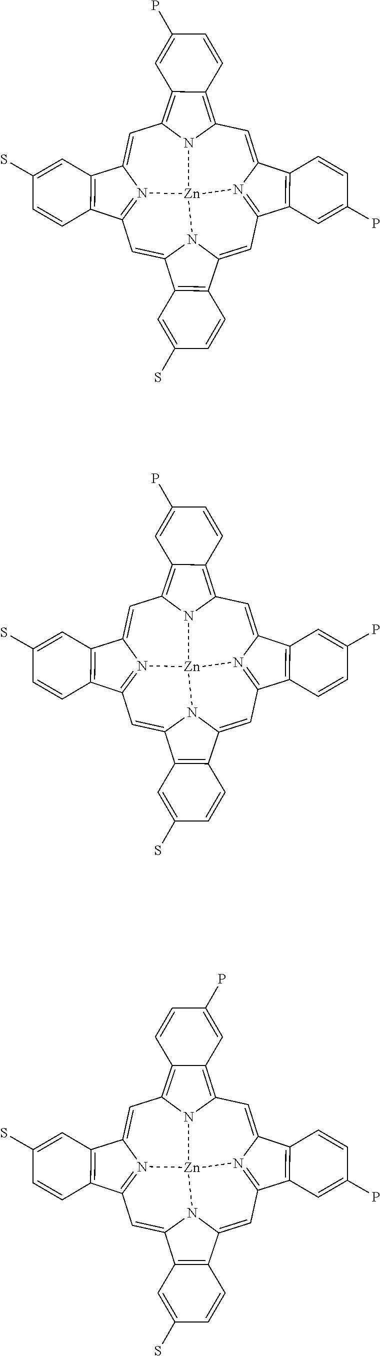

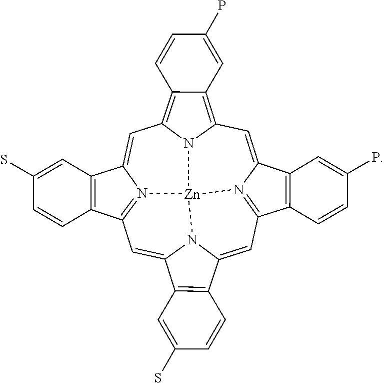

The fillers in the fine separation column can be YMC*Gel Exphere C18 10μ, YMC*Gel Exphere C18 20μ, Daisogel C18 10μ or Capcell PaR C18 UG-80 20μ, and the fillers in the rough separation column can be YMC*Exphere C18 50μ, Daisogel C18 50 μ or Capcell PaR C18 UG-80 50μ.

In the process of preparing zinc phthalocyanine, a step 1d) of column enrichment is carried out after the step 1c): the cis-enriched fractions of zinc phthalocyanine obtained at the step 1c) is pumped into an enrichment column which has fillers the same as those used in the rough separation; then a 10%˜30% (volume) DMF aqueous solution and a 70%˜80% (volume) DMF aqueous solution, both being the same pH value as those in injection step are used in turns; and the enriched fractions of zinc phthalocyanine are collected as the starting substances for step 2).

In the process of preparing zinc phthalocyanine, a step 2d) of solvent replacement is carried out after the step 2c): the DMF aqueous solution in the fractions obtained at the step 2c) is replaced with acetonitrile aqueous solution by means of column replacement method. The pH value of each solution is controlled in the range of 8.0 to 8.2. Fillers for a chromatography column are reverse-phase silica gels.

The fractions after the solvents have been replaced are made into solid products by using a freeze-drying process.

The effect of the invention is superior to the existing technology. The use of mixture of four zinc phthalocyanine monomers according to the present invention offers significantly improved photodynamic effect in terms of cancer cell growth inhibition, compared to an original mixture of 15 isomers including cis- and trans-monomers, or a mixture of 10 cis-monomers. Please see the following experiments and comparative examples.

Photodynamic Activity of Tumor Cells In Vitro with Comparative Experiments
By using MTT (tetrazolium salt) reduction on tumor cells which have been treated by a photosensitizer and radiated by 670 nm laser, the effect of the concentration of the photosensitizer on inhibition of tumor cell growth is illustrated by dotting a dose-response curves and calculating the median effective concentration (IC₅₀). The results are shown in Table 1.

The inhibition effect of ZnPc series photosensitizers on the tumor cells in vitro is compared. In the table 1, the 4 cis-isomers are the composition of the 4 zinc phthalocyanine isomers as provided by the invention. The 10 isomers are meant to be 10 possible cis-isomers of ZnPcS₂P₂. The trans-isomers are meant to be all possible trans-isomers of ZnPcS₂P₂.

TABLE 1

| | IC50 (μM) | | |
|---|---|---|---|
| Cell strains | Cis-(10 isomers) | Cis-(4 isomers) | Trans- |
| HELF (Human | 0.46 | 0.044 | 0.58 |
| embryonic lung | 0.042 | 0.039 | 0.093 |
| fibroblasts) | 0.010 | 0.0027 | 0.017 |
| BGC823 (Human gastric | | | |
| cancer cells) | | | |
| K562 (Human leukemia | | | |
| cells) | | | |

From Table 1, among the compositions of photosensitizers (10 cis-isomer composition, 4 cis-isomer composition and trans-isomer composition) in terms of required concentration for 50% inhibition (IC₅₀) on growth of three cancer cells, the 4 cis-isomer composition shows the best inhibition effect.

Other objectives, advantages and features of the present invention will become apparent from the following description referring to the attached drawings.

### BRIEF DESCRIPTION OF THE DRAWINGS

The present invention will be described via detailed illustration of the preferred embodiment versus prior art referring to the drawings where:

FIG. 1 is a HPLC graph of zinc phthalocyanine obtained by “semi-phthalocyanine ring” synthetic method according to a first embodiment of the invention.

FIG. 2 is a HPLC graph of roughly separated fractions collected in a first embodiment of the invention.

FIG. 3 is a HPLC graph of finely separated fractions collected in a first embodiment of the invention.

FIG. 4 is a HPLC graph of finely separated fractions collected in a second embodiment of the invention.

FIG. 5 is a HPLC graph of finely separated fractions collected in a third embodiment of the invention.

### DETAILED DESCRIPTION OF THE INVENTION

All terms in the content of this specification are described below.

1. All the liquids—concentrations of liquid components of liquid immiscible system are indicated in volume. For example, 65% DMF aqueous solution means the volume of DMF in the solution is 65%;

2. In description of the starting substances and the fillers, the weight of the fillers means the dry weight thereof;

3. In the course of the whole separation process, the temperature is controlled in the range of normal room temperature, that is 20˜35° C. If the temperature falls out of this range, viscosity and other parameters of the solution will change, causing failure to reach effects as described in the embodiment;

4. HPLC analysis of intermediates and final products:
1) Chromatographic conditions for analysis of synthesized product components:

Chromatographic conditions for column Luna 15 cm*0.46 mm 5 μm, column temperature of 30° C.;

| | | | % A | |
|---|---|---|---|---|
| | Time | Flow | (10 mM TEA | % B |
| | (min) | (ml/min) | pH ≈ 5.1) | (CH₃CN:DMF = 30%:70%) |
| 1 | 0.01 | 1.00 | 95 | 5 |
| 2 | 5.00 | 1.00 | 95 | 5 |
| 3 | 25.00 | 1.00 | 0 | 100 |
| 4 | 30.00 | 1.00 | 0 | 100 |

In the spectra, ZnPcS₄ can be recognized from the peak of 15˜16 min, ZnPcS₃P can be recognized from the peaks of 19˜21 min, trans ZnPcS₂P₂ can be recognized from the peak of 23 min, cis-ZnPcS₂P₂ can be recognized from the peak of 23.5˜25 min, ZnPcSP₃ can be recognized from the peak of 27 min peak, and ZnPcP₄ can be recognized from the peak of 30.5 min.

2) Chromatographic conditions for analysis of the roughly separated product components

Chromatographic column Shiseido CAPCELL PAK C18 15 cm*0.46 cm, 5 μm. Chromatographic conditions are as follows: column temperature of 30° C.;

| | | | % A | % B |
|---|---|---|---|---|
| | Time | Flow | (20 mM TEA | (THF:MeOH:DMF = |
| | (min) | (ml/min) | pH ≈ 5.1) | 15%:10%:75%) |
| 1 | 0.01 | 1.00 | 53 | 47 |
| 2 | 120.00 | 1.00 | 53 | 47 |

In the spectra, 10 peaks between 25˜110 min indicate cis-ZnPcS₂P₂.

3) Chromatographic conditions for analysis of the finely separated product components
Chromatographic column SHIMADZU SHI-PACK VP-ODS 15 cm*0.46 cm 5 μm. Chromatographic conditions are as follows: column temperature of 30° C.;

| | | | % A | % B |
|---|---|---|---|---|
| | Time | Flow | (10 mM TEA | (THF:MeOH:DMF = |
| | (min) | (ml/min) | pH ≈ 5.1) | 15%:10%:75%) |
| 1 | 0.01 | 1.00 | 50 | 50 |
| 2 | 120.00 | 1.00 | 50 | 50 |

In the spectra, 4 peaks between 40˜65 min indicate 4 target products of cis-ZnPcS₂P₂.

### Example 1

### Starting Substances

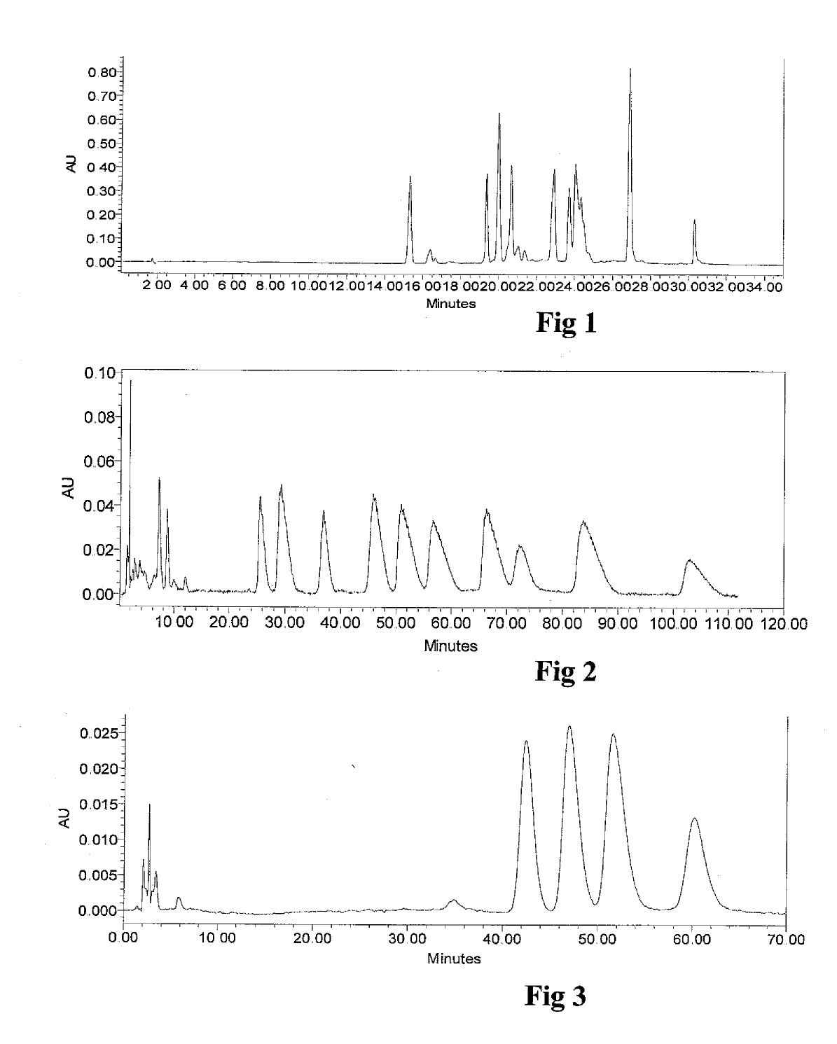

The conventional “semi zinc phthalocyanine ring” is used to prepare zinc phthalocyanine mixture. The zinc phthalocyanine mixture contains cis- and trans-isomers of ZnPcS₂P₂, 15 in total, and ZnPcS₄, ZnPcS₃P, ZnPcSP₃ and ZnPcP₄, along with fragments of other starting substances and intermediates thereof. HPLC spectra of the obtained products are shown in FIG. 1.

1) Rough separation:
a. Balancing through a rough separation column: the rough separation column has a packed length of 300 mm and a diameter of 50 mm, and fillers are Japanese YMC*Exphere C18 50μ,
b. Injection: take a certain amount of the starting substances to make 65% DMF aqueous solution of pH 7.0 to 8.0. The 65% DMF aqueous solution is pumped into the rough separation column. In the above solution, the content of contains zinc phthalocyanine content is 0.5% of filler weight. The concentration of zinc phthalocyanine is 8 g/L. Injection column temperature is 20° C. The injection flow rate=100 ml/min.
c. Elution: pH 7.0˜8.0 DMF aqueous solutions at different concentrations are used in turns for elution. The concentration of DMF aqueous solutions are in the range of 10% to 100%. During the elution, a low-concentration DMF aqueous solution is first pumped into the column and then a high-concentration of DMF solution.

Specifically, a mixture of 10% DMF-90% water is first used for 10-min elution. Thereafter a mixture of 30% DMF-70% water is used to elution for 20 minutes. Then a mixture of 50% DMF-50% water is used for 5 minutes. A mixture of 63% DMF-37% water is used in turns for 15 minutes. Then the mixture is changed to be 65% DMF-35% water and used for further 5 minutes. Finally, 100% DMF is used to wash the column for 10 minutes. The elution flow rate maintains the same, namely the flow rate 100 ml per minute, during the whole process.

The components of the eluent are correspondingly collected and, cis-enriched fractions of zinc phthalocyanine are obtained. The eluting column temperature is 20° C. The HPLC results of the collected fractions are shown in FIG. 2.
d. Column enrichment: The cis-enriched fractions of zinc phthalocyanine obtained at the step 1c) are pumped into an enrichment column which has fillers the same as those used in the rough separation. Then a 10% DMF aqueous solution and a 70% DMF aqueous solution, both being the same pH value as those used in injection step. The enriched fractions of zinc phthalocyanine are collected.

2) Fine separation:
a. Balancing through a fine separation column: the column has a packed length of 700 mm and a diameter of 100 mm. The fillers are Japanese YMC*Gel Exphere C18 10μ (alternatively YMC*Gel Exphere C18 20μ);
b. Injection: take the roughly separated substances to make a 60% DMF aqueous solution with pH 8.0 to 8.2. The aqueous solution is pumped into the fine separation column. In the above solution, the content of zinc phthalocyanine is 0.10% of filler weight. The concentration of zinc phthalocyanine is 5 g/L. The injection column temperature is 20° C. The injection flow rate is 80 ml/min;
c. Elution: pH 8.0˜8.2, 60% DMF aqueous solution is used as a flowing phase for elution in the fine separation column. The eluting column temperature is 20° C. The elution flow rate is 200 ml/min. According to the composition of the eluent used here, four isomer-enriched fractions of zinc phthalocyanine are collected. The HPLC results of the collected facts are shown in FIG. 3.
d. Solvent Replacement: The fractions obtained at the step 2 c) are pumped into a replacement column. The fillers are the same as those used in for fine separation column. A 65% acetonitrile aqueous solution, having the same pH value as that used for injection, is used for elution. Target fractions are then collected.

3) Column regeneration after separation (rough separation column and fine separation column), by using the following solutions in turns:
The column is washed by using a 90% DMF aqueous solution until it is colorless. A 10% DMF aqueous solution is used for 2 to 3 column washing cycles. A 10% DMF solution (adjusted with acetic acid until the pH value becomes 2˜3) is used for 2 to 3 column washing cycles. A 10% methanol aqueous solution is then used. Finally, 100% methanol is used.

### Example 2

The steps are the same as those in Example 1, except that some conditions are changed as follows.

The starting substances are unchanged.

1) Rough separation:
a. Balancing through a rough separation column: the rough separation column has a packed length of 600 mm and a diameter of 100 mm, and fillers are Japanese Daisogel C18 50μ,
b. Injection: take a certain amount of the starting substances to make 70% DMF aqueous solution of pH 7.0 to 8.0. The 70% DMF aqueous solution is pumped into the rough separation column. In the above solution, the content of contains zinc phthalocyanine content is 0.20% of the weight of the fillers. The concentration of zinc phthalocyanine is 12 g/L. Injection column temperature is 28° C. The injection flow rate=400 ml/min.
c. elution: The eluting column temperature is 28° C. The remaining conditions are the same as those in Example 1.
d. column enrichment: A 20% DMF aqueous solution and a 75% DMF aqueous solution are used in turns for elution. The enriched fractions of zinc phthalocyanine are then collected.

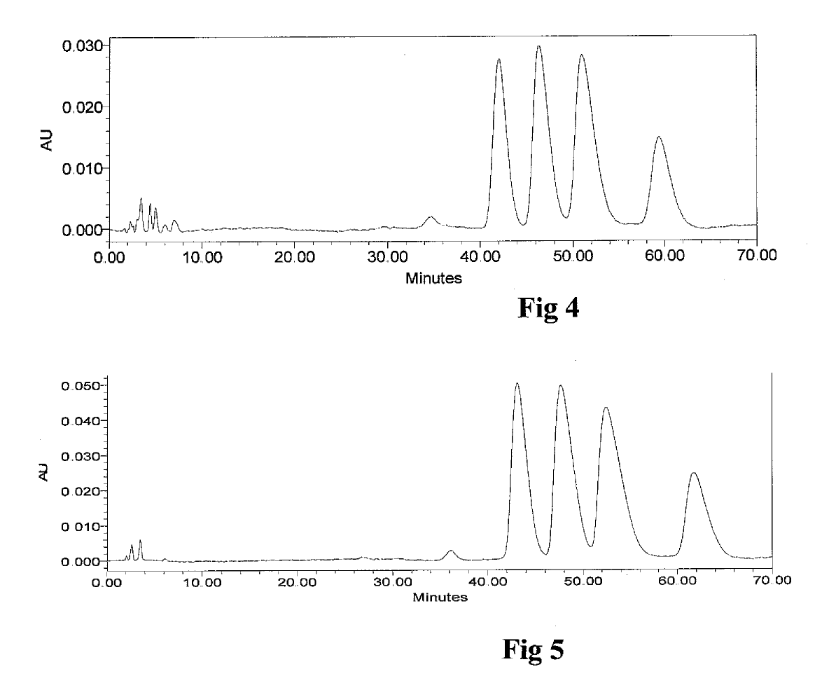

2) Fine separation:
a. Balancing through a fine separation column: the fine separation column has a packed length of 800 mm and a diameter of 150 mm. The fillers are Japanese Daisogel C18 10μ;
b. Injection: take the roughly separated substances to make a 62% DMF aqueous solution with pH 8.0 to 8.2. The aqueous solution is pumped into the fine separation column. In the above solution, the content of zinc phthalocyanine is 0.10% of filler weight. The concentration of zinc phthalocyanine is 7 g/L. The injection column temperature is 28° C. The injection flow rate is 150 ml/min,
c. Elution: pH 8.0˜8.2, 62% DMF aqueous solution is used as a flowing phase for elution in the fine separation column. The eluting column temperature is 28° C. The elution flow rate is 450 ml/min. According to the composition of the eluent used here, four isomer-enriched fractions of zinc phthalocyanine are collected. The HPLC results of the collected fractions are shown in FIG. 4.
d. Solvent Replacement: The fractions obtained at the step 2 c) are pumped into a replacement column. The fillers are the same as those used in for fine separation column. A 70% acetonitrile aqueous solution, having the same pH value as that used for injection, is used for elution. Enriched fractions of zinc phthalocyanine are then collected.

### Example 3

The starting substances are unchanged.

1) Rough separation:
a. Balancing through a rough separation column: the rough separation column has a packed length of 1000 mm and a diameter of 200 mm, and fillers are Capcell PaR C18 UG-80 5μ;
b. Injection: take the starting substances to make 65% DMF aqueous solution of pH 7.0 to 8.0, and pump the DMF solution into the rough separation column. In the above solution, the content of contains zinc phthalocyanine content is 0.35% of the filler weight. The concentration of zinc phthalocyanine is 15 g/L. Injection column temperature is 35° C. The injection flow rate=800 ml/min.

c. elution: The eluting column temperature is 28° C. The remaining conditions are the same as those in Example 1.
d. column enrichment: The conditions are the same as those in Example 1, except that a 30% DMF aqueous solution and a 80% (volume) DMF aqueous solution are used in turns for elution. The enriched fractions of zinc phthalocyanine are then collected.

2) Fine separation:
a. Balancing through a fine separation column: the fine separation column has a packed length of 1000 mm and a diameter of 200 mm. The fillers are Capcell PaR C18 UG-80 20μ;
b. Injection: take the roughly separated substances to make a 65% DMF aqueous solution with pH 8.0 to 8.2. The aqueous solution is pumped into the fine separation column. In the above solution, the content of zinc phthalocyanine is 0.12% of filler weight. The concentration of zinc phthalocyanine is 10 g/L. The injection column temperature is 35° C. The injection flow rate is 400 ml/min;
c. Elution: pH 8.0˜8.2, 65% DMF aqueous solution is used as a flowing phase for elution in the fine separation column. The eluting column temperature is 35° C. The elution flow rate is 800 ml/min. According to the composition of the eluent used here, four isomer-enriched fractions of zinc phthalocyanine are collected. The HPLC graphs of the collected fractions are shown in FIG. 5;
d. Solvent Replacement: The fractions obtained at the step 3 c) are pumped into a replacement column. The fillers for the replacement column are the same as those used in for fine separation column. A 5% acetonitrile aqueous solution and a 75% acetonitrile aqueous solution, both having the same pH value as that used for injection, are used for elution in turns. Thereafter, 5% acetonitrile aqueous solution is used first for 5 cycles before the use of the 75% acetonitrile aqueous solution. The target enriched fractions are then collected.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A pharmaceutical composition containing zinc phthalocyanine composition, characterized in that the above zinc phthalocyanine composition comprises the following four isomers of zinc phthalocyanine: 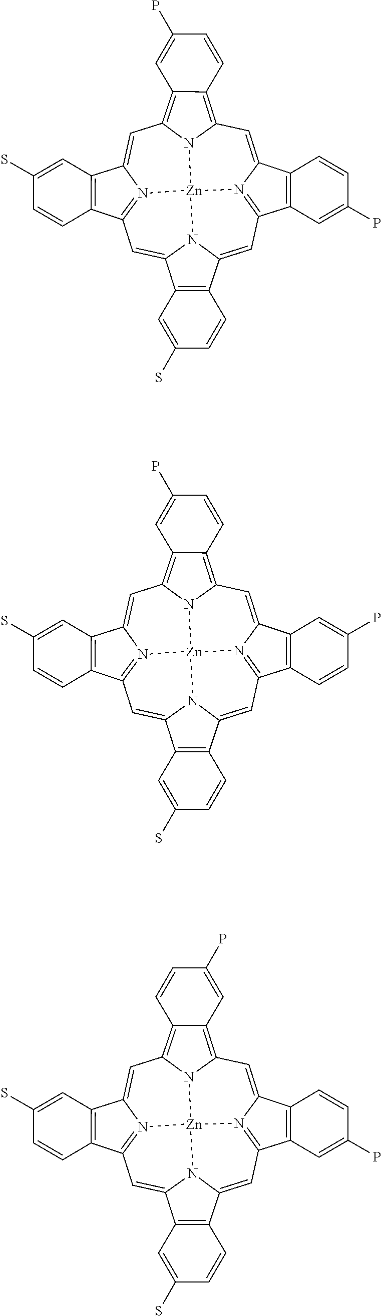 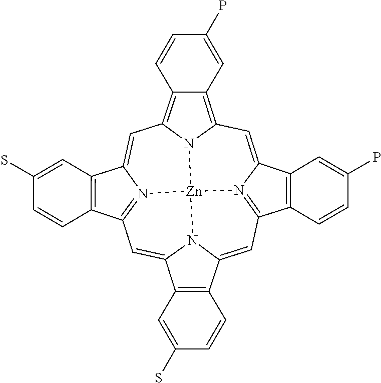
wherein —S— is —SO₃⁻M⁺, and M⁺ is a pharmaceutically acceptable cation; —P is

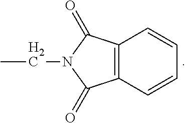

2. An use of a zinc phthalocyanine composition used in photodynamic therapy for cancer or precancerous lesions, characterized in that the above zinc phthalocyanine composition comprises the following four isomers of zinc phthalocyanine, 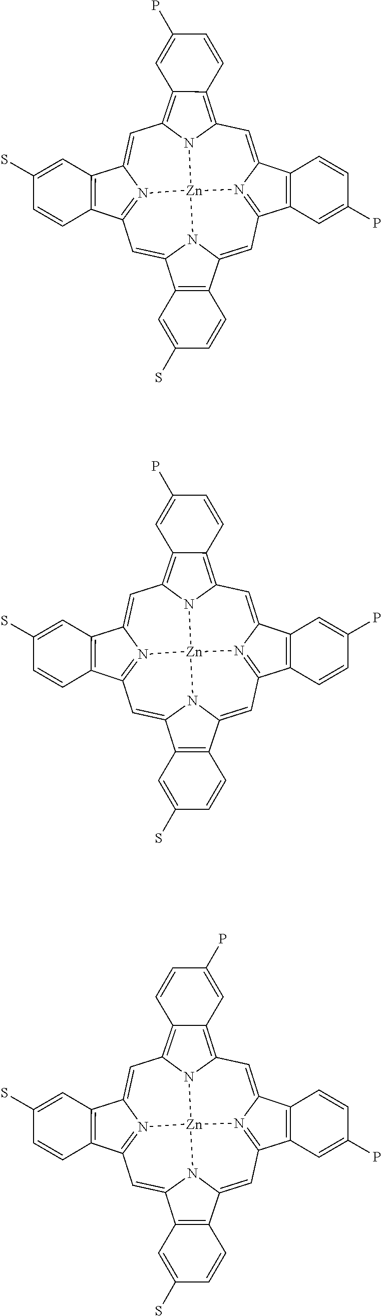 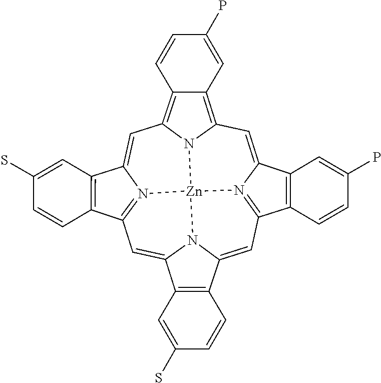
wherein —S— is —SO₃⁻M⁺, and M⁺ is a pharmaceutically acceptable cation; —P is

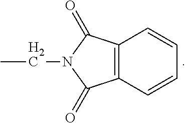

3. The use of claim 2, characterized in that the above M⁺ is an alkaline metallic ion.

4. The use of claim 3, characterized in that the above M⁺ is potassium ion.

5. A process of preparing zinc phthalocyanine, characterized in that starting substances in the process comprise ZnPcS₄, ZnPcS₃P, ZnPcS₂P₂, ZnPcSP₃ and ZnPcP₄, and the process comprises the following steps: wherein —S— is —SO₃⁻M⁺, and M⁺ is a pharmaceutically acceptable cation; —P is 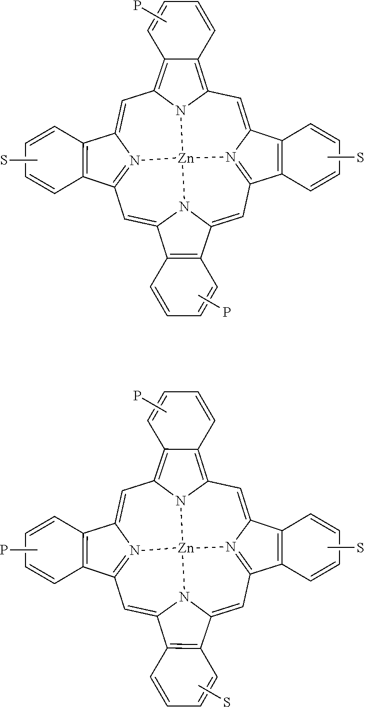
wherein —S— is —SO₃⁻M⁺, and M⁺ is a pharmaceutically acceptable cation; —P is 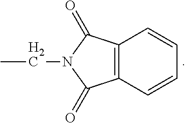
1) Rough separation:
a. Balancing through a rough separation column: the rough separating column has a packed length of 300˜1000 mm, a diameter of 50˜200 mm, a pore diameter of 100˜120 Å, carbon loading of 17%˜19%, with C18 filler having particle size of 20˜50 μm,
b. Injection: take starting substances to make a 65% to 70% (volume) DMF aqueous solution with pH 7.0 to 8.0. The aqueous solution is pumped into the rough separation column. In the above solution, the content of zinc phthalocyanine is 0.2% to 0.5% of filler weight. The concentration of zinc phthalocyanine is 8˜15 g/L. The injection column temperature is 20˜35° C. The injection flow rate=S×a, where S is cross-sectional area of the rough separation column, in units of cm², and a is a coefficient in the range of 2.5˜5.0 cm;
c. Elution: pH 7.0˜8.0 DMF aqueous solutions at different concentrations are used in turns for elution. The concentration of the above DMF solutions is in the range of 10% to 100% (volume). During the elution process, a low-concentration DMF solution is first pumped into the column, and then a high-concentration DMF solution is pumped. According to the composition of the eluent used here, cis-enriched fractions of zinc phthalocyanine are sequentially collected. The eluting column temperature is 20˜35° C. The elution flow rate=S×a, where S is cross-sectional area of the rough separation column, in units of cm², and a is a coefficient in the range of 2.5˜5.0 cm;
2) Fine separation:
a. Balancing through a fine separating column: The fine separation column has a packed length of 700˜1000 mm, a diameter of 100˜200 mm, a pore diameter 100˜120 Å, and a carbon loading of 19%˜21%, with C18 fillers having particle size of 10˜20 μm;
b. Injection: take the roughly separated substances to make a 60% to 65% (volume) DMF aqueous solution with pH 8.0 to 8.2. The aqueous solution is pumped into the fine separation column. In the above solution, the content of zinc phthalocyanine is 0.10% to 0.12% of filler weight. The concentration of zinc phthalocyanine is 5˜10 g/L; the injection column temperature is 20˜35° C.; the injection flow rate=S×a, where S is cross-sectional area of the fine separation column, in units of cm², and a is a coefficient in the range of 0.85˜1.3 cm,
c. Elution: pH 8.0˜8.2 DMF aqueous solutions at different concentrations of 60%˜65% are used as a flowing phase for elution in the fine separation column; The eluting column temperature is 20˜35° C. The elution flow rate=S×a, where S is cross-sectional area of the fine separation column, in units of cm², and a is a coefficient in the range of 0.85˜1.3 cm; and according to the composition of the eluent used here, four isomer-enriched fractions of zinc phthalocyanine are collected.

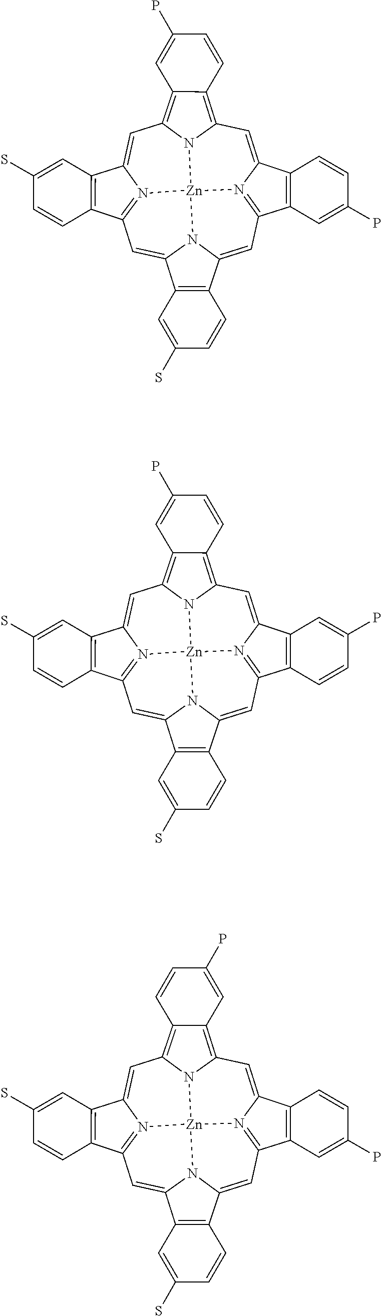

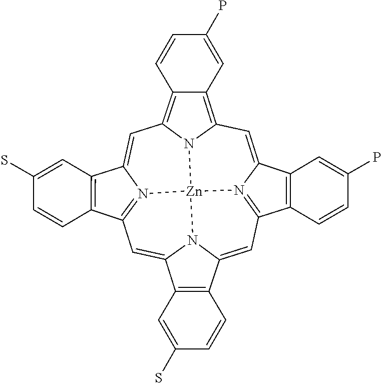

6. The process of claim 5, characterized in that the fillers in the fine separation column are YMC*Gel Exphere C18 10μ, YMC*Gel Exphere C18 20μ, Daisogel C18 10μ or Capcell PaR C18 UG-80 20μ, and the fillers in the rough separation column are YMC*Exphere C18 50μ, Daisogel C18 50μ or Capcell PaR C18 UG-80 50μ.

7. The process of claim 5, characterized in that a step 1d) of column enrichment is carried out after the step 1c): the cis-enriched fractions of zinc phthalocyanine obtained at the step 1c) are pumped into an enrichment column which has fillers the same as those used in the rough separation, then a 10%˜30% (volume) DMF aqueous solution and a 70%˜80% (volume) DMF aqueous solution, both being the same pH value as those in injection step, and the enriched fractions of zinc phthalocyanine are collected as the starting substances for step 2).

8. The process of claim 5, characterized in that a step 2d) of solvent replacement is carried out after the step 2c): the DMF aqueous solution in the fractions obtained at the step 2c) is replaced with acetonitrile aqueous solution by means of column replacement method; the pH value of each solution is controlled in the range of 8.0 to 8.2; and fillers for a chromatography column are reverse-phase silica gels.

9. The process of claim 8, characterized in that the fractions after the solvents have been replaced are made into solid products by using a freeze-drying process.
